(19) United States
(12) Patent Application Publication
(10) Pub. No.: US 2014/0106394 A1
(43) Pub. Date: Apr. 17, 2014

(54) MULTIWELL PLATE AND METHOD OF ANALYZING TARGET MATERIAL USING THE SAME

(71) Applicant: Samsung Electronics Co., Ltd., Suwon-si (KR)

(72) Inventors: Eun KO, Anyang-si (KR); Moon-sook Lee, Seoul (KR)

(73) Assignee: Samsung Electronics Co., Ltd., Suwon-si (KR)

(21) Appl. No.: 14/055,360

(22) Filed: Oct. 16, 2013

(30) Foreign Application Priority Data
Oct. 16, 2012 (KR) 10-2012-0115024

(51) Int. Cl. B01L 3/00

(52) U.S. Cl. CPC B01L 3/5085
USPC 435/30; 422/552; 435/29

(57) ABSTRACT

Provided is a multiwell plate for an easy liquid removal, wherein the mutiwell plate includes a well with at least one pore in the sidewall defining the well, and a method of analyzing a target material using the multiwell plate.

### CROSS-REFERENCE TO RELATED APPLICATIONS

This application claims the benefit of Korean Patent Application No. 10-2012-0115024, filed on Oct. 16, 2012, in the Korean Intellectual Property Office, the entire disclosure of which is hereby incorporated by reference.

### BACKGROUND

1. Field

The present disclosure relates to multiwell plates for an easy liquid removal and a method of analyzing target materials using the multiwell plates.

2. Description of the Related Art

An experimental plate including a multiwell or a reaction chamber is used for various purposes and analyses. Also, the multiwell plate is used for a cell culture.

When cells are cultured in a well of a multiwell plate, a culture medium used in the well may be replaced periodically. In this case, replacing the culture medium may involve a manual or an automatic machine to remove the culture medium used in the well and supply a new culture medium.

However, the process is inefficient because the process may involve removing or replacing the culture medium of each well of the multiwell plate.

### SUMMARY

Provided are multiwell plates for an easy liquid removal. In one aspect, there is provided a multiwell plate comprising at least one first well defined by a bottom wall and a side wall connected to the bottom wall along the periphery of the bottom wall, wherein the well comprises at least one pore in the side wall. In another aspect, there is provided A multiwell plate set comprising the first multiwell plate and a second multiwell plate a second multiwell plate comprising a second well having a dimension that accommodates the first well of the first multiwell plate, such that the first well of the first multiwell plate can be inserted into the second well of the second multiwell plate.

Also provided are methods of analyzing a target material using the multiwell plate or plate set. According to one aspect, the method comprises introducing a sample including a target material into the first well of the first multiwell plate of claim; and inserting the first well of the first multiwell plate into a second well of a second multiwell plate.

According to an aspect of the present invention, the multiwell plate may be used for an efficient culturing or analysis of the target material.

According to another aspect of the present invention, a method of a target material analysis may prevent loss of the target material and analyze a great amount of the target material.

### BRIEF DESCRIPTION OF THE DRAWINGS

These and/or other aspects will become apparent and more readily appreciated from the following description of the embodiments, taken in conjunction with the accompanying drawings of which:

FIGS. 1A and 1B are plane views of a first well;

FIGS. 2A and 2B illustrate a first multiwell plate with at least one first well;

FIG. 3A is a side view of a first multiwell plate and a second multiwell plate;

FIG. 3B illustrates a first well and a second well;

FIG. 3C illustrates a first well inserted into a second well;

FIG. 4 illustrates a second multiwell plate including a chamber below the second well

FIG. 5 illustrates the second well plate of FIG. 4, wherein the bottom of the second well is closed;

FIG. 6 illustrates the second well plate of FIG. 4, wherein the bottom of the second well is opened;

FIG. 7 illustrates a method of analyzing a target material using a first multiwell plate;

FIGS. 8 and 9 illustrate a method of replacing a culture medium, drug treatment, staining or washing; and

FIGS. 10A and 10B illustrate a side view and a top view of the spheroid formation in a first well that is inserted into a second well.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of at least one of the associated listed items. Expressions such as “at least one of,” when preceding a list of elements, modify the entire list of elements and do not modify the individual elements of the list.

Additional aspects will be set forth in part in the description which follows and, in part, will be apparent from the description, or may be learned by practice of the presented embodiments.

According to an aspect of the present invention, a first multiwell plate includes at least one of a first well that has a top, a bottom, and a side wall that has at least one pore at or above a first location. The well is principally defined by a bottom member or wall and a side wall connected to the bottom wall along the periphery of the bottom wall, wherein the well comprises at least one pore in the side wall. The top is an opening defined by an edge of the sidewall opposite the bottom wall.

According to another aspect of the present invention, with respect to the first multiwell plate, a multiwell plate set is provided further including a second well plate, which has second wells, and the first well of the first multiwell plate is inserted into the second wells. In other words, the second well has a dimension that accommodates the first well of the first multiwell plate, such that the first well of the first multiwell plate can be inserted into the second well of the second multiwell plate. The second multiwell plate may be commonly known in the field. The second multiwell plate may be a U shaped plate.

The plane views of the first well and/or the second well may be circular or polygonal. For example, the shape may be rectangular or pentagonal. The top width of the first well may be bigger than the bottom width of the first well. When the top is circular, the top width refers to a diameter of the circle.

With respect to the first well, a portion of the side wall may be partially composed of a porous material. The porous material may be polytetrafluoroethylene, polyethylene, PET, polycarbonate, cellulose, polypropylene, or an inorganic material such as aluminum oxide. Because the side wall is composed of the porous material with at least one pore through which a target material does not penetrate and whereas a liquid component does, the liquid component may be transported from the interior to the exterior of the first well. The pore may be of a size through which the target material does not penetrate. The length of a narrowest cross section of the pore is shorter than the length of the narrowest cross section of the target material. When the pore is circular, the length refers to a diameter of the circle. The pore size may be smaller than the size of the target material. As an example of the pore size, the diameter of the narrowest cross section may be about 50 μm to about 100 μm, about 55 μm to about 95 μm, about 60 μm to about 90 μm, about 65 μm to about 85 μm, or about 70 μm to about 80 μm. Also, the number of pores may vary depending on the type of the target material, the diameter of the pore, the length of the side wall, and the first location.

A side wall of at least one first well of the first multiwell plate may not partially contact another adjacent side wall of a first well. The side wall of the first well adjacent to another side wall of a first well may contact at the top. The side wall of the first well may not contact partially an adjacent side wall of a first well because the top of the first well is bigger than the bottom of the first well.

The term “target material” used herein refers to a subject of analysis that is to be located in the first well. The target material may include at least one material selected from the group consisting of a spheroid, a tissue, a small organ, and a cell. The term “spheroid” used herein includes an aggregate, mass, cluster, or assembly of cells prepared by a mutual adhesion of the cells and/or a cell colony when the cell and/or cell colony are/is lightly contacting in a floating state. The spheroid may refer to an aggregate, a mass, a cluster or an assembly of cells cultured to allow three-dimensional growth in contrast to the two-dimensional growth of cells either in a monolayer or in a cell suspension. The aggregate may be highly organized with a well defined morphology or it may be a mass of cells that have clustered or adhered together with little organization reflecting the tissue of origin. It may comprise a single cell type, i.e., homotypic or more than one cell type, i.e., heterotypic. The cells are primary isolates but may also include a combination of primary isolates with an established cell line(s). The heterotypic spheroid may be prepared from various cells from at least one of a primary cell, a cell strain, a cancer cell, and a stem cell. The spheroid may have a spherical form or an irregular form. The spheroid may include a different cell group, a different cell type, or a cell in a different condition, for example, a proliferating cell, a resting cell, or a necrotic cell. Also, the spheroid includes a three dimensional tissue called a micro-tissue or a micro-organ, which has the same or a similar structure and/or function as a native tissue, or a native organ. The size and shape of the spheroid may vary depending on type of cell, seeding density, culture medium formation, or culture condition.

Also, a carrier for the target material may be needed to introduce the target material into the first well. The carrier may be a buffer solution known in the field. The buffer solution may be, for example, Tris-HCl or a phosphate buffer solution. Also, a culture medium known in the field may be needed to culture the target material in the first well.

The wellplates may comprise an array of a plurality of the first or second wells. The term “array” used herein refers to an ordered arrangement of the first wells on the multiwell plate having a uniform spacing. The first well plate with more than one first well may include an arrangement of two or more wells. The wells may be uniformly arranged, for example, in parallel or uniformly dislocated with respect to each other. For example, the wellplate may contain 6-wells, 24-wells, 48-wells, 96-wells, 384-wells, or 1536-wells.

The first location is a position on the side wall at a given distance from the bottom wall, i.e., a position located in a pathway leading vertically from the bottom of the first well to the top of the first well. A sample including the cell may fill the first well up to the first location. The first location (e.g., distance of the first location from the bottom wall) may be decided according to the spheroid size, the number of cells corresponding to the spheroid size, size of cell, or the amount of the culture medium. The first location may be located at a distance from the bottom of, for example, about 0.1 mm to about 5 mm, about 1 mm to about 4.5 mm, about 1.5 mm to about 4 mm, or about 2.5 mm to about 3.5 mm.

The width of the bottom of the first well may be decided according to the size of the target material. When the target material is selected from the group consisting of a spheroid, a tissue, a small organ, and a combination thereof, the width of the bottom of the first well may be suitable for locating at least one target material at the bottom. The width of the bottom of the first well may be a length of the narrowest cross section of about 0.5 to about 1, about 0.6 to about 0.9, or about 0.7 to about 0.8 mm. When the bottom of the first well is circular, the width represents a diameter of the circle. Also, the width of the top and the bottom of the first well may be the same. When the widths of top and the bottom of the first well are the same, a first well may have smaller top and bottom widths than the top and the bottom widths of the second well, so as to allow the second well to accommodate the first well. The bottom of the first and/or the second well may be configured for observing the target material. For example, the bottom of the first well and/or the second well may be transparent to light or a magnetic field, such that it may be possible for light or magnetic field to penetrate the well and allow observation.

With respect to the first well, the thickness of the bottom of the first well may be configured for observing the target material included in the first well. The observation may be performed by using at least one of a microscope, an optical measuring device, an electrical measuring device, and a magnetic measuring device. The thickness of the bottom may be controlled according to the observation method. When the thickness is measured using a microscope, the thickness of the bottom may be about 0.01 mm to about 0.20 mm, about 0.03 mm to about 0.18 mm, about 0.05 mm to about 0.16 mm, about 0.7 mm to about 0.14 mm, or about 0.09 mm to about 0.12 mm. As a higher resolution microscope is used, the thickness of the bottom may be thinner.

The bottom of the first and/or second well may be flat or concave. When the bottom is flat, a target material may be observed in the first well because there is no space between the bottom of the first well and the bottom of the second well when the target material is inserted into the second well by contacting the bottom of the second well.

A length between the top and the bottom represents a vertical length (perpendicular to the plane of the bottom wall) between the top and the bottom. The length of the first well may be about 5 mm to about 15 mm, about 6 mm to about 14 mm, about 7 mm to about 13 mm, about 8 mm to about 12 mm, or about 9 mm to about 11 mm.

The length of the first well may be shorter than a vertical length between the top and the bottom of the second well. The bottom of the first well may contact the bottom of the second well when the first well is inserted into the second well. As the bottom of the first well contacts the bottom of the second well, the first well and the second well may be serially connected, e.g. layered, and the first multiwell plate including the first well and the second multiwell plate including the second well may also be layered.

A non-adhesive coating material may be coated on the upper portion of the bottom of the first well (i.e., the interior surface of the bottom wall, facing the interior of the well). The coating material may facilitate an aggregation of the cells by preventing an adhesion between the first well and the cell, such that a spheroid may be formed. The coating material may be an agarose thin film, or a hydrophobic material, for example, poly-HEMA (poly (2-hydroxyethyl methacrylate)) or poly-N-p-vinylbenzyl-D-lactonamide.

The first multiwell plate may further include a lid on the top of the first multiwell plate that covers one or more (or all) of the wells of the first multiwall plate.

The size of the first well and/or the second well, for example, may depend on the amount of the target material or the amount of a solution in the well. The entire or a part of the first multiwell plate and/or the second multiwell plate may be made of a moldable material, for example, a plastic. For example, the moldable material may be selected from the group consisting of polyethylene, polypropylene, polystyrene and a combination thereof. The first well and/or the second well may be made of a material suitable for a cell culture.

The second multiwell plate include a chamber located at the bottom of the second well, and the top surface of the chamber is defined by the bottom of the second well, and may have a chamber including the bottom and the side wall. The chamber may be coupled detachably at the bottom of the second well. In other words, the bottom of the second well may be detachably coupled to the sidewall or other part defining the second well, such that the bottom of the second well is movable and can be opened and closed, such that the second well and the chamber are fluidly connected when the bottom of the second well is opened and the second well and the chamber are separated by the bottom surface and not fluidly connected when the bottom of the second well is closed. The bottom of the second well is located between a pair of electrodes, wherein one electrode of the pair may be located at the top of the second well, and the other electrode may be located at the bottom of the chamber. In other words, the electrodes of the electrode pair may be located in the second well and chamber, respectively, and separated by the bottom of the second well when closed. At least one of the bottom of the chamber and the side wall of the chamber may be open and closable.

Also, regarding the multiwell plate set, the first multiwell plate, the second multiwell plate, and/or the lid of the multiwell plate may include a commonly used device in the field, for example, a device that is operably connected to a robot arm. The device may have a generally spatular-shape that is operably connected to the robot arm that may move the multiwell plate. The robot arm used may be a robot arm commonly known in the field. The robot arm may be a robot arm used in a High Throughput Screening (HTS). A device operably connected to the robot arm may be include in a part of the first multiwell plate and/or the second multiwell plate. Also, the device may be included in a lid of the second multiwell plate.

Also, the multiwell plate set may further include a target material observation device that is disposed such that a target material in the first well is observed. An example of the target material observation device may be an optical observation device. The target material observation device may be selected from the group consisting of a microscope, an optical measuring device, an electrical measuring device, and a magnetic measuring device, or a combination thereof.

According to another aspect of the present invention, a method of analyzing a target material includes: locating a sample including a target material into a first multiwell plate (e.g., the first well of the first multiwall plate) as described herein and inserting the first well of the first multiwell plate into the second well of the second multiwell plate as described herein.

With respect to the first well, the first multiwell plate, the second well and the second multiwell plate used in the method, all aspects are as previously described herein. The target material may be at least one material selected from the group consisting of a spheroid, a tissue, a small organ and a cell. The spheroid may be prepared by one selected from the group consisting of Hanging drop, liquid overlay, Spinner flasks, NASA rotary system, Micromolding, 3-D scaffolds, PNIPAAm (poly-N-isopropylacrylamide) cell sheet, Primaria dishes, Galactosylated substrates, Pellet culture, Monoclonal growth, External force enhancement, and a combination thereof. The tissue or the small organ may be prepared by a tissue culture or by an organotypic culture.

Also, the method may further include a process of inflowing a liquid into the second well of the second multiwell plate. The liquid may be one selected from the group consisting of a culture medium, a solution including a drug, a staining solution, a washing solution, and a combination of these.

Also, the method may further include a process of penetrating a liquid or a cell into at least one pore of the first well by moving the first multiwell plate, while preventing the penetration of the target material through the at least one pore. The liquid may be one selected from the group consisting of a culture medium, a solution including a drug, a staining solution, a washing solution, and a combination thereof. The moving may involve lifting the first well, or lifting and tilting the first well. Also, the bottom of the second well may be reversibly openable and closable, such that the liquid or the cell of the second well may move downwards by opening the bottom or by suction. Also, by using the second well, the second multiwell plate, or the multiwell plate set including a chamber thereof, the liquid or the cell may move to the chamber by opening the bottom.

Also, the method may further include observing the target material. The observation may be performed by using one or a combination of a microscope, an optical measuring device, an electrical measuring device, and a magnetic measuring device. Also, the observation may be performed to observe a spheroid image. The observation may be performed by a device selected from the group consisting of a fluorescence confocal microscopy, a micro-magnetic resonance microscopy, a positron-emission tomography, and an optical sectioning microscopy.

Also, the method may further include preparing a spheroid by centrifugation of the first multiwell plate. The spheroid may be prepared by centrifuging a sample including the cell in the first well of the first multiwell plate, inserted into the second well of the second multiwell plate. A height of the side wall of the first well may depend on the amount of cells and the amount of culture medium corresponding to the spheroid size. When the cells and the culture medium included up to the first location of the first well and the cells and the culture medium are centrifuged, the cells may gradually cohere and rearrange to form a spheroid. Because the bottom of the first well is smaller than its top, there may be one spheroid formed at the bottom. By deciding a suitable diameter at the bottom, there may be one spheroid formed at the bottom. The cell may be a prokaryotic cell or an eukaryotic cell. For example, the cell may be an animal cell. The cell may be a suspension cell or an adherent cell. The animal cell may be a human cell, a murine cell, a bovine cell, a porcine cell, an equine cell, a rabbit cell, or a goat cell.

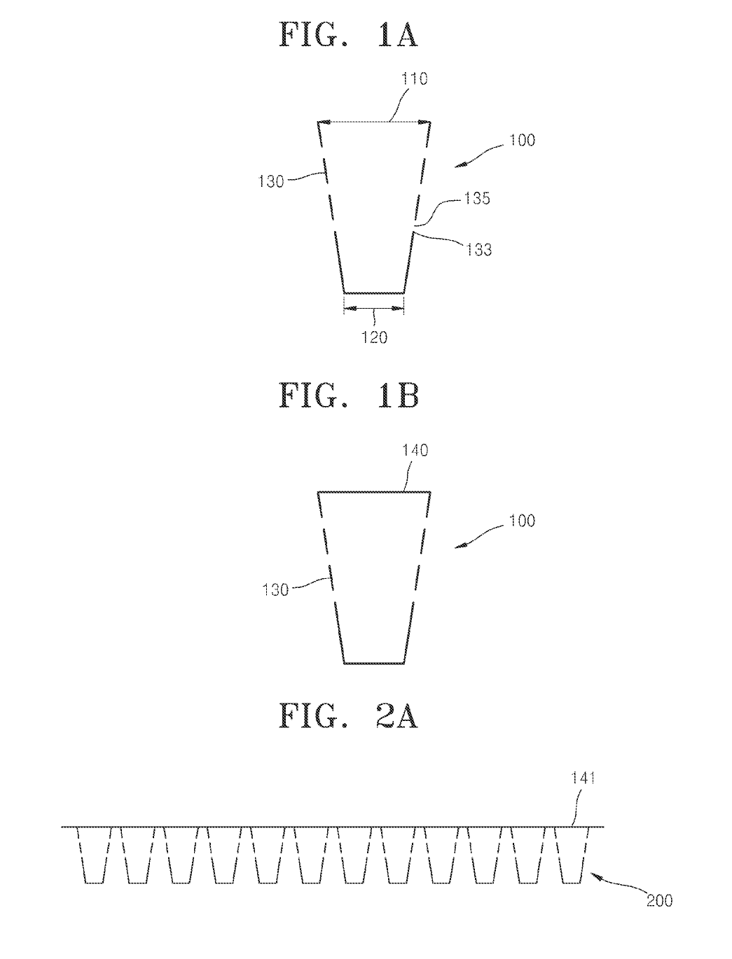

FIGS. 1A and 1B represent a plane figure of the first well, according to an embodiment of the present invention.

As shown in FIG. 1A, the first well 100 includes a top opening 110, a bottom 120, and a side wall 130 with at least one pore 135 above a first location 133. The side wall 130 has at least one pore because the side wall 130 is made of a porous material above the first location 133. The pore may be used to remove a liquid or a cell and to prevent the penetration of a target material. The pore size may be smaller than the target material size. Because the pore size is smaller than the target material size, the liquid or the cell may be removed by a penetration through the pores. The size of the top 110 may be bigger or the same as its bottom 120. The size of the bottom 120 is the length of a line passing through the middle of the narrowest cross section, which is about 0.5 to about 1 mm. The size of the bottom 120 is used to form one spheroid in the first well 100. The bottom 120 may be flat.

As shown in FIG. 1B, the first well 100 includes a lid 140 at the top. The lid 140 may be used to prevent loss of a sample including the target material. The lid 140 may be coupled detachably to the first well such that the first well 100 may be closed or opened. The lid may be coupled detachably to the top 110 of the first well 100 such that the first well 100 may be closed or opened.

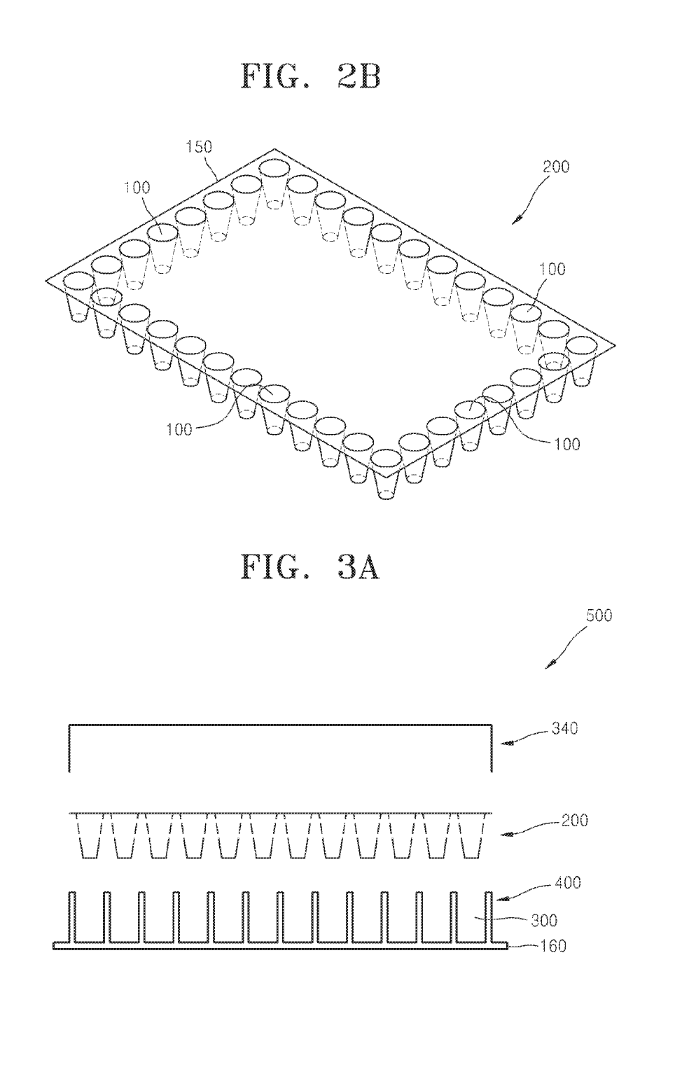

FIGS. 2A and 2B represent a first multiwell plate having at least one first well, according to an embodiment of the present invention. As shown in FIG. 2A, the first multiwell plate 200 has at least one first well. The top width of the first well is greater than the bottom width thereof. This may be used to facilitate the liquid or the cell to penetrate through to the exterior, and prevent the liquid or the cell from flowing into an adjacent first well. The first multiwell plate 200 further includes a lid 141 at the top 110. The lid 141 may be coupled detachably at the top of the first multiwell plate 200. As shown in FIG. 2B, the first multiwell plate 200 includes an array of first wells 100 in two arrangements. The arrangement may be a uniform arrangement of the first well 100, for example, arranged in parallel or uniformly dislocated with respect to each other. A plate of the first multiwell plate 200 may include a protrusion 150 which is the outer surface of the area where arrays of the first well are located. The protrusion 150 of the first multiwell plate 200 may be moved by connecting the protrusion 150 of the first multiwell plate 200 to a commonly used device in the field, for example, a robot arm. The plate of the first multiwell plate 200 may include a further protrusion on the outer surface of the area where arrays of the first well 100 are located.

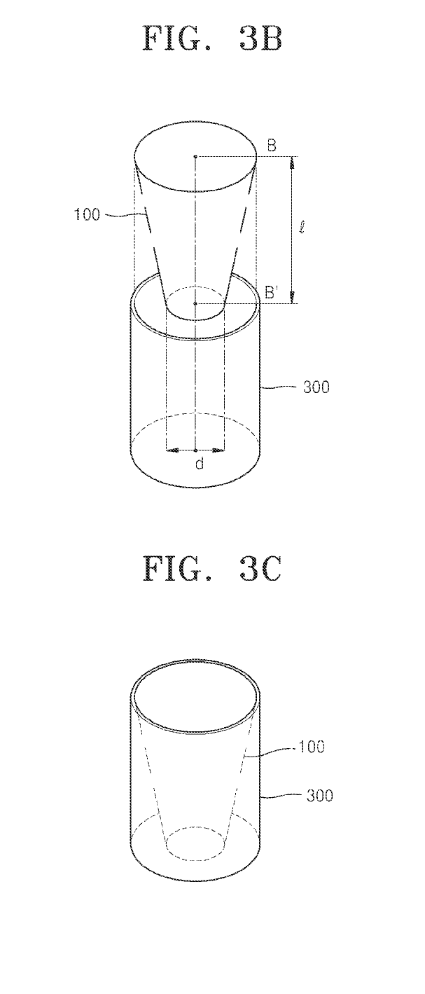

FIG. 3A illustrates side views of the first multiwell plate and a second multiwell plate. As shown in FIG. 3A, a multiwell plate set 500 includes the first multiwell plate 200, and the second multiwell plate 400. The second multiwell plate 400 has a plurality of second wells 300. The plate of the second multiwell plate 400 may form a protrusion 160 on the outer surface where a plurality of arrays of the second well 300 is located. The protrusion 160 of the second multiwell plate 400 may be moved by connecting the protrusion of the second multiwell plate 400 to a commonly used device in the field, for example, a robot arm. Also, the second multiwell plate 400 may further include a lid 340 at the top of the second multiwell plate 400. The lid 340 may be coupled detachably from the second well 300 or the second multiwell plate 400, such that the first well 100, the first multiwell plate 200, the second well 300, and/or the second multiwell plate 400 may be opened or closed. The lid 340 may be detached by connecting to a commonly used device in the field, for example, a robot arm.

FIG. 3B illustrates the first well and the second well, according to an embodiment of the present invention. As shown in FIG. 3B, the first well 100 is inserted into the second well 300 in a B-B′ direction. A length (I) between the top and the bottom of the first well 100 may be of the same length or shorter than a length between the top and the bottom of the second well 300. A diameter of the top of the first well 100 may be the same or shorter than a diameter of the top of the second well 300. A diameter of the bottom of the first well 100 (d) is shorter than the width of the bottom of the second well 300. Also, with respect to the first well 100 according to an embodiment of the present invention, when the top and the bottom of the first well 100 are of the same size, the first well 100 including a smaller first well (not shown) with a smaller top and bottom sizes than the first well 100 is inserted into the second well 300, and the liquid and/or the cell may be removed through the pore.

FIG. 3C illustrates the first well inserted into the second well, according to an embodiment of the present invention. As shown in FIG. 3C, the first well 100 is inserted into the second well 300.

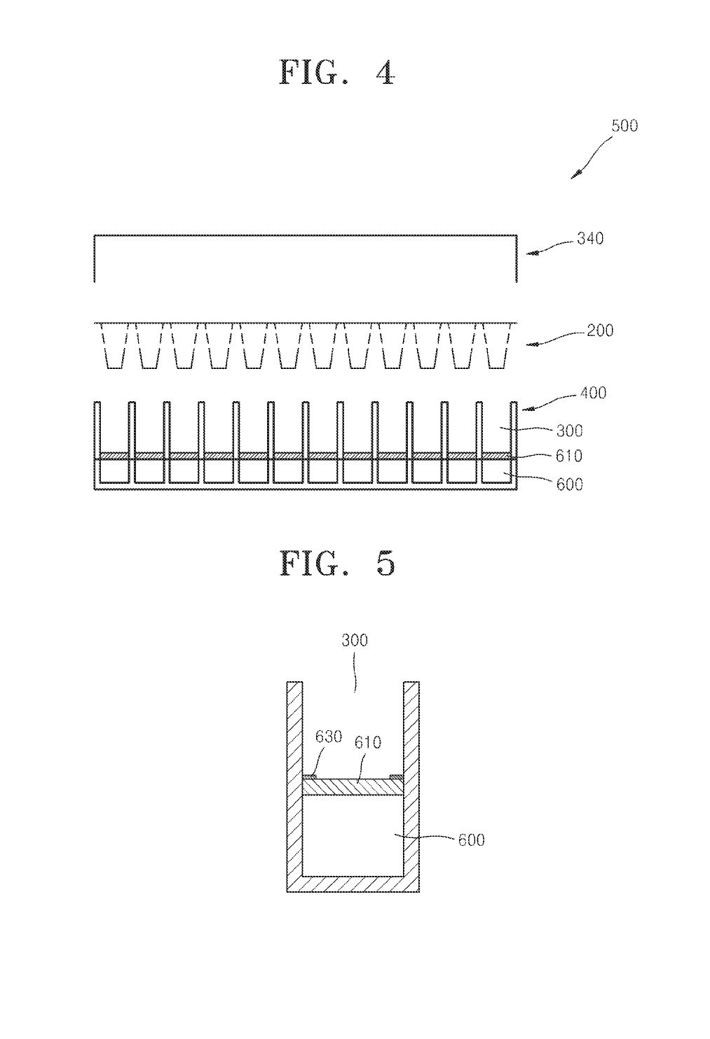

FIG. 4 illustrates the second multiwell plate including a chamber at the bottom of the plate, according to an embodiment of the present invention. As shown in FIG. 4, the second multiwell plate 400 may include a chamber 600 located beneath the second well 300, a top surface 610 of the chamber 600 is defined by the bottom of the second well 300. The chamber 600 may include the bottom of the chamber and a side wall. Each bottom of the second well 300 may be located between a pair of electrodes, wherein one of the electrodes is located at the top of the second well 300 and the other electrode is located at the bottom of the chamber 600. The chamber may include an openable and closable element selected from at least one of the bottom of the chamber, the side wall of the chamber, or both.

FIG. 5 illustrates a closed state of the bottom of the second well in the second multiwell plate in FIG. 4. As shown in FIG. 5, due to a protrusion 630, the bottom 610 may be sealed with respect to the second well 300 and both ends may be sealed with respect to the side wall, such that the liquid in the second well 300 is prevented from flowing into the chamber 600. The protrusion 630 is optional, and it is possible for the arrangement to be made without the protrusion 630. The bottom 610 may be opened by a rotation of one of the ends. The bottom 610 may be arranged in a way possible for rotating to the bottom direction, by having one of the ends as a rotational axis. The bottom 610 may be open and closed by mechanical or electrical forces. The bottom 610 may electrically open and close because the bottom 610 is made of an electroactive substance that bends when a voltage is permitted between the materials. The electroactive substance may be an electroactive hydrogel. For example, the electroactive substance may be a hydrogel that includes an acrylic acid, a methacrylic acid, or a combination thereof. The electroactive substance may be a hydrogel composed of a conducting polymer.

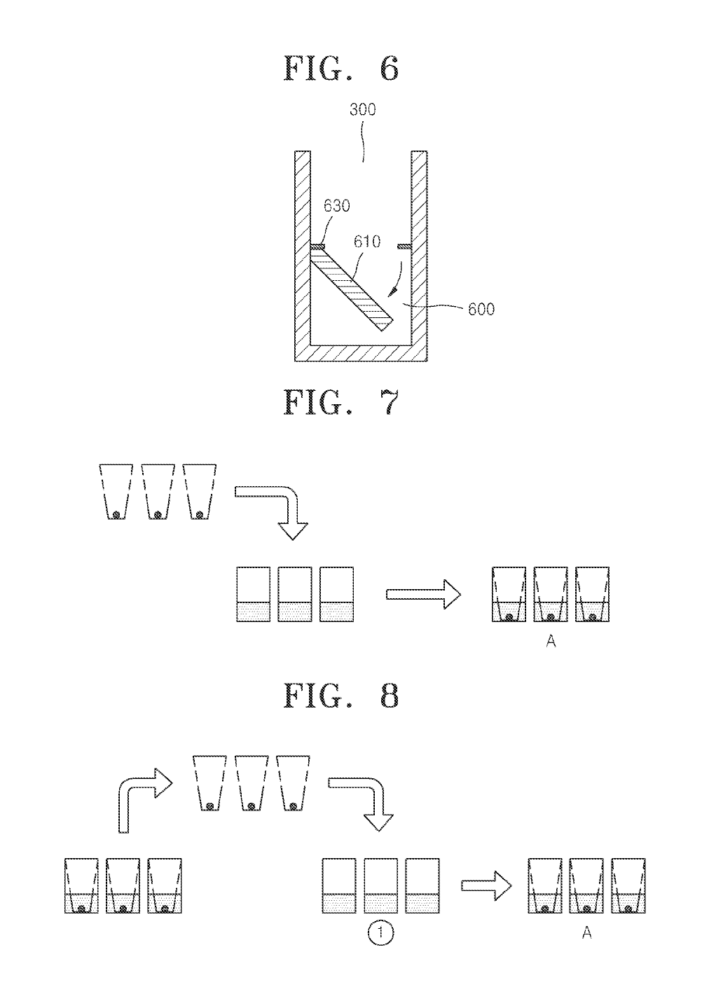

FIG. 6 illustrates an open state of the bottom of the second well of the second multiwell plate in FIG. 5. As shown in FIG. 6, the bottom 610 of the second well 300 is opened by rotating to the bottom direction, while having the left terminal as a rotational axis, and as a result, the liquid or the cell of the second well 300 may be moved to the chamber 600.

FIG. 7 illustrates a method of a target material analysis by using a first multiwell plate, according to an embodiment of the present invention. As shown in FIG. 7, a sample including the target material may be located in the first well. The target material may be cultured in a sample containing the target materials located in the first well. The first well including the sample containing the target material may be inserted into the second well. In the second well, materials used for a cell culture may be included.

FIG. 8 illustrates methods of changing a culture medium, drug treatment, staining, or washing, using the first multiwell plate according to an embodiment of the present invention. As shown in FIG. 8, the second well is separated from the first well by moving the first well including the target material, inserted into the second well. The moving may involve lifting the first well or lifting and tilting the first well. The move may be hand-operated or automatic. When the first well is lifted, the liquid or the cell may be removed by at least one of the pores located on the side wall of the first well. When lifting and tilting the first well, the target material may not penetrate the pore, and as a result, the target material may be captured in the first well. Through the moving, the target material may not have to be directly moved to another plate. Also, the bottom of the second well may be reversibly openable and closable, such that the liquid or the cell may move downwards by opening the bottom or by suction. By opening the bottom of the second well and tilting the multiwell plate set, the liquid and the cell may move downwards through the first pore while the target material does not penetrate the pore of the first well (not shown). Also, by using the second well, the second multiwell plate, the multiwell plate set including a chamber at the bottom of the second well, the second multiwell plate, and the multiwell plate set, the bottom of these may be opened such that the liquid or the cell may be moved to the chamber (not shown). When replacing a culture medium, drug treatment, staining, or washing are performed in the first well including the target material, loss of the target material may be prevented, and the target material may be maintained in the first well. The liquid may be a culture medium, a solution including a drug, a staining solution, or a washing solution. Also, corresponding to the pore diameter, a cell with a smaller diameter than the pore may be removed. The first well including the target material is inserted into the second well \textcircled{1}. The second well \textcircled{1} includes the culture medium, the solution including a drug, or the staining solution.

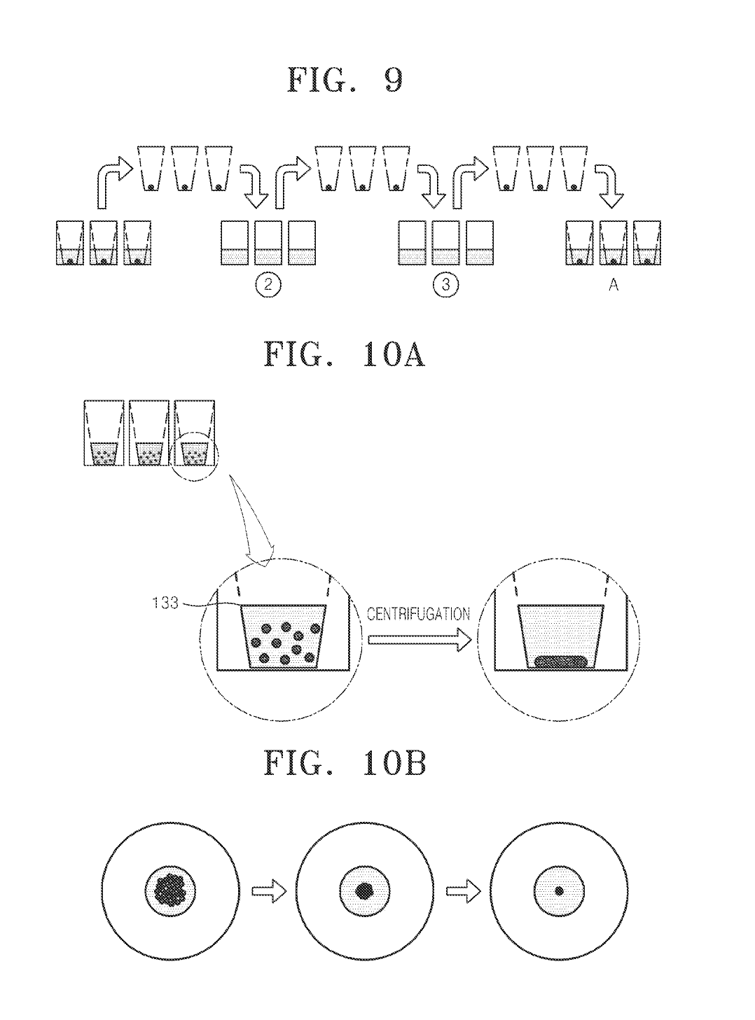

FIG. 9 illustrates methods of replacing a culture medium, drug treatment, staining, or washing, using the first multiwell plate, according to an embodiment of the present invention. As shown in FIG. 9, a plurality of treatments are performed in the first well including the sample that includes the target material. The first well including the target material is inserted into the second well including the staining solution, then the first well is separated from the second well \textcircled{2}, and then the separated second well \textcircled{2} is inserted into the second well \textcircled{3} including the washing solution. By moving the first well that is inserted into the second well \textcircled{3}, the first well is lifted, or lifted and tilted to remove the washing solution, and then the first well is inserted into the second well A. The target material included in the first well is observed, wherein the first well is inserted into the second well A. Using an optical sectioning device, the target material is observed at a high resolution.

FIG. 10A is a side view of a spheroid formation in the first well that is inserted into the second well, according to an embodiment of the present invention. As shown in 10A, with respect to the sample including the cell, the sample that includes the cell inserted in the first well that is inserted into the second well, is centrifuged and cultured to form a spheroid. The sample including the cell includes up to the first location 133 of the first well. Because there is no pore below the first location 133 of the first well, loss a spheroid forming cell may be prevented, while the centrifugation is in progress. Because the spheroid may be formed in the first well, the spheroid analysis in the first well is possible without moving the spheroid from the first well to another plate.

FIG. 10B represents a top view of the spheroid formation in the first well that is inserted into the second well, according to an embodiment of the present invention. As shown in FIG. 10B, after centrifuging and culturing the sample including the cell that is included in the first well that is inserted into the second well, the cells gradually aggregate and rearrange to form the spheroid. In detail, as the cells gradually aggregate, a loose aggregate is formed, and as the loose aggregate rearranges, a tight aggregate; hence, a spheroid is formed. As the bottom of the first well is smaller than the top of the first well, one spheroid may be formed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A multiwell plate comprising at least one first well defined by a bottom wall and a side wall connected to the bottom wall along the periphery of the bottom wall, wherein the well comprises at least one pore in the side wall.

2. A multiwell plate set comprising:
a first multiwell plate according to claim 1; and
a second multiwell plate comprising a second well having a dimension that accommodates the first well of the first multiwell plate, such that the first well of the first multiwell plate can be inserted into the second well of the second multiwell plate.

3. The first multiwell plate of claim 1, wherein the sidewall has an edge opposite the bottom wall that defines a top opening, and wherein the top opening is wider than the bottom wall width.

4. The first multiwell plate of claim 1, wherein the pore is smaller than a spheroid, a tissue, an organ, or a cell.

5. The first multiwell plate of claim 1, wherein the side wall of the first well does not contact a side wall of another well of the first multiwell plate.

6. The first multiwell plate of claim 1, wherein the multiwall plate comprises an array of first wells.

7. The first multiwell plate of claim 1, wherein the pore is located in the sidewall about 0.1 to about 5 mm from the bottom wall.

8. The first multiwell plate of claim 1, wherein a narrowest part of the bottom wall has a width about 0.5 to about 1 mm

9. The first multiwell plate of claim 4, wherein a narrowest part of the pore has a width about 50 to about 100 μm.

10. The first multiwell plate of claim 1, wherein the bottom is flat or concave and protrudes away from the interior of the well.

11. The first multiwell plate of the claim 1, wherein sidewall has an edge opposite the bottom wall that defines a top opening, and the top opening is separated from the bottom wall by a distance of about 5 to about 15 mm.

12. The first multiwell plate of claim 1, wherein the bottom wall has an interior surface facing the interior of the well, and the interior surface of the bottom is coated with a coating material.

13. The first multiwell plate of claim 1, wherein the first multiwell plate further comprises a lid covering the top opening of the first well.

14. The multiwell plate set of claim 2, wherein the second multiwell plate includes a chamber beneath the second well, wherein the chamber comprises a bottom and a side wall, and the top surface of the chamber is defined by the bottom of the second well.

15. The multiwell plate set of claim 14, wherein the bottom of the second well is located between a pair of electrodes, wherein one electrode is located at the top of the second well while the other electrode is located at the bottom of the chamber.

16. The multiwell plate set of claim 14, wherein the bottom of the chamber, the side wall of the chamber, or both are movable and can be opened and closed.

17. A method of analyzing a target material, comprising:
introducing a sample including a target material into the first well of the first multiwell plate of claim 1; and
inserting the first well of the first multiwell plate into a second well of a second multiwell plate.

18. The method of claim 17, wherein the method further comprises inflowing a liquid into the second well of the second multiwell plate.

19. The method of claim 17, further comprising moving the first multiwell plate such that the liquid penetrates through the at least one pore of the first well, wherein the target material cannot penetrate the pore.

20. The method of claim 17, further comprising centrifuging the first multiwell plate, to form a spheroid.
